(19) United States
(12) Patent Application Publication
(10) Pub. No.: US 2004/0140875 A1
(43) Pub. Date: Jul. 22, 2004

(54) Unipolar magnetic system

(76) Inventor: Carl H. Strom, Bonita Springs, FL (US)

Correspondence Address: William F. Hamrock, P.A., 50 Winter Harbor Road, Kennebunkport, ME, 04046, US

(21) Appl. No.: 10/431,240

(22) Filed: May 7, 2003

Related U.S. Application Data
(60) Provisional application No. 60/441,595, filed on Jan. 22, 2003.

(51) Int. Cl. H01F 7/02

(52) U.S. Cl. 335/306

(57) ABSTRACT

A unipolar-magnetic system has one or more external magnetic poles (1) oppositely charged magnetically from one or more internal magnetic poles (2) of a unipolar-magnet object. Included can be a plurality of bipolar magnets juxtaposed with inter-polar side walls (3) being affixed in contact or separated with magnetic insulation side-by-side peripherally on a unipolar-magnetic object. The unipolar-magnetic object with inter-polar sidewalls affixed in contact is magnetically analogous to a single bipolar magnet having a first north or south pole external from an internal second oppositely south or north pole with the internal pole surrounding either a void, a nonconductor or a magnetically transitory conductor. Bipolar magnetism for the unipolar-magnetic system can be permanent or electrically charged. The unipolar-magnetic system can be used for a wide variety of lifting, cleaning, gaming, entertainment, prime-mover and other applications.

The present application claims priority to U.S. Provisional Application of Carl Strom, Serial No. 60/441,595, filed Jan. 22, 2003, the entirety of which is incorporated into the present application by reference.

### BACKGROUND OF THE INVENTION

1. Field of the Invention

This invention relates to unipolar magnets.

2. Relation to prior art.

Known magnets are bipolar with positive (north) polarity oppositely disposed from negative (south) polarity. Contrastingly, a unipolar-magnetic system has single polarity, either north or south, externally or internally on a unipolar magnetic item.

Bipolar magnets are well known and highly variant, but there are no known unipolar magnetic systems as taught by this invention. Examples of most-closely related known but different magnetic devices are described in the following patent documents:

| Number | Date | Inventor | U.S. Class |
|---|---|---|---|
| U.S. Pat. No. 5,883,454 | Mar. 16, 1999 | Hones et al. | 310/90.5 |
| U.S. Pat. No. 5,404,062 | Apr. 04, 1995 | Hones et al. | 310/90.5 |
| US Des. 268,912 | May 10, 1983 | Gushea | D11/141 |
| US Des. 259,581 | Jun. 16, 1981 | Kretschmer | D21/240 |
| U.S. Pat. No. 4,251,791 | Feb. 27, 1981 | Yanagisawa et al. | 335/302 |
| U.S. Pat. No. 3,196,566 | 07/27.65 | Littlefield | 40/106.3 |
| U.S. Pat. No. 3,184,654 | May 18, 1965 | Bey | 317/159 |

### SUMMARY OF THE INVENTION

Objects of patentable novelty and utility taught by this invention are to provide a uniform-magnetic system which can be used for:

levitating and optionally rotating a unipolar-magnetic object over a same magnetic-polarity surface as an exterior surface of the unipolar-magnetic object indefinitely;

a rotor for an efficient permanent-magnet prime mover;

a wide variety of machinery components, gaming devices and entertainment devices;

cleaning iron particles from tubular conveyances of machinery, from internal portions of metal machinery, from foundry equipment, from containers, from water and from various all-directional areas;

lifting scrap iron from junk yards, from vehicles and from storage areas for processing;

cleaning stray pins, fasteners and metal objects from work areas and from clothing;

removing metal-wear particles from engine lubricant;

removing electrically short-circuiting metal particles and dust from air circulated through electronic and electrical equipment;

making frictionless bearings; and

cleaning rust from radiators.

This invention accomplishes these and other objectives with a unipolar-magnetic system having one or more external magnetic poles oppositely charged magnetically from one or more internal magnetic poles of a unipolar object. Included can be a plurality of bipolar magnets juxtaposed with inter-polar side surfaces being affixed in contact or separated side-by-side peripherally by magnetic insulation on a unipolar-magnetic object. The unipolar-magnetic object with inter-polar side surfaces affixed in contact is magnetically analogous to a single bipolar magnet having a first positive or south pole external from an internal second oppositely south or positive pole with the internal pole surrounding either a void, a nonconductor or a magnetically transitory conductor. Bipolar magnetism for the unipolar-magnetic system can be permanent or electrically charged.

### BRIEF DESCRIPTION OF DRAWINGS

This invention is described by appended claims in relation to description of a preferred embodiment with reference to the following drawings which are explained briefly as follows:

FIG. 1 is an end elevation view of a unipolar-magnetic system having bipolar a plurality of bar magnets arranged circumferentially with north magnetic poles facing outward radially, with south magnetic poles facing inward centrally and with wedge-shaped magnetic insulation preventing magnetic communication or leakage between the opposite poles and between adjacent bipolar magnets;

FIG. 2 is a side elevation view of the FIG. 1 illustration that further includes end insulation and a break to indicate longer or shorter length between ends;

FIG. 3 is an end elevation view of the unipolar-magnetic system having bipolar bar magnets arranged circumferentially with south magnetic poles facing outward radially, with north magnetic poles facing inward centrally and with magnetic insulation preventing magnetic communication or leakage between the opposite poles and between adjacent bipolar magnets;

FIG. 4 is an end elevation view of the unipolar-magnetic system having a plurality of wedge-shaped bipolar bar magnets arranged circumferentially with north magnetic poles facing outward radially, with south magnetic poles facing inward centrally and with uniform-width magnetic insulation preventing magnetic communication or leakage between the opposite poles and between adjacent bipolar magnets;

FIG. 5 is a side elevation view of the FIG. 1 illustration that further includes end insulation;

FIG. 6 is an end elevation view of the unipolar-magnetic system having wedge-shaped bipolar bar magnets arranged circumferentially with north magnetic poles facing outward radially, with south magnetic poles facing inward centrally and without magnetic insulation, but with contact of sides of adjacent wedge-shaped bipolar bar magnets for preventing magnetic communication or leakage between the opposite poles;

FIG. 7 is a side elevation view of the FIG. 6 illustration that further includes end insulation;

FIG. 8 is an end elevation view of the unipolar-magnetic system having wafer magnets that are wedge-shaped bipolar bar magnets arranged circumferentially with north magnetic poles facing outward radially, with south magnetic poles facing inward centrally and with magnetic insulation between sides for preventing magnetic communication or leakage between the opposite poles;

FIG. 9 is an end elevation view of the unipolar-magnetic system having wafer magnets that are wedge-shaped bipolar bar magnets arranged circumferentially with south magnetic poles facing outward radially, with north magnetic poles facing inward centrally and with magnetic insulation between side walls;

FIG. 10 is the FIG. 8 illustration without magnetic insulation and with magnetic insulation between sidewalls for preventing magnetic communication or leakage between the opposite poles;

FIG. 11 is an end elevation view of the unipolar-magnetic system having wafer magnets that are wedge-shaped bipolar bar magnets arranged circumferentially with south magnetic poles facing outward radially, with north magnetic poles facing inward centrally and without magnetic insulation between sides;

FIG. 12 is an end elevation view of the unipolar-magnetic system having a unitary unipolar magnet with a north magnetic pole facing outward radially, with a south magnetic pole facing inward centrally and with a plurality of plane faces;

FIG. 13 is an end elevation view of the unipolar-magnetic system having a unitary unipolar magnet with a north magnetic pole facing outward radially, with a south magnetic pole facing inward centrally and with a circumferential face;

FIG. 14 is an end elevation view of a plurality of arcuate wafer magnets positioned circumferentially with north magnetic poles facing outward radially and with south magnetic poles facing inward centrally;

FIG. 15 is a side elevation view of the FIG. 14 illustration that further includes end insulation;

FIG. 16 is a partially cutaway elevation view of a unipolar-magnetic system having arcuate wafer magnets positioned spherically with north magnetic poles facing outward radially and with south magnetic poles facing inward centrally;

FIG. 17 is a partially cutaway elevation view of a unipolar-magnetic system with a north magnetic pole facing outward and with a south magnetic pole facing inward spherically;

FIG. 18 is a partially cutaway elevation view of the FIG. 16 illustration with addition of a tool handle extended from a central portion for use as a magnetic cleaner;

FIG. 19 is a partially cutaway elevation view of the FIG. 17 illustration with addition of a tool handle extended from a central portion for use as a magnetic cleaner;

FIG. 20 is a side elevation view of the FIG. 15 illustration that further includes rotor axles for use as a permanent-magnetic rotor;

FIG. 21 is an end elevation view of the unipolar-magnetic system having wafer magnets that are wedge-shaped bipolar bar magnets positioned perpendicularly with north magnetic poles facing outwardly and with south magnetic poles facing inwardly;

FIG. 22 is an end elevation view of the unipolar-magnetic system having wafer magnets that are bipolar bar magnets positioned perpendicularly with north magnetic poles facing outwardly, with south magnetic poles facing inwardly and with magnetic insulation at joining ends;

FIG. 23 is a partially cutaway side elevation view of the FIG. 6 illustration that further includes an electrically wired lift handle extended from a central portion and bipolar magnets having electromagnet coils for heavy lifting applications;

FIG. 24 is a side elevation view of the FIG. 23 illustration;

FIG. 25 is a partially cutaway side elevation view of the FIG. 20 illustration that further includes magnetic fins for magnetic-resistence actuation by stator magnets;

FIG. 26 is a cross-section of a portion of FIG. 25 through section line 25-25 of FIG. 25;

FIG. 27 is a partially cutaway side elevation view of the FIG. 25 illustration with a FIG. 13 unitary unipolar magnet.

FIG. 28 is a partially cutaway side elevation view of the FIG. 16 illustration levitated by a cupped magnet; and

FIG. 29 is a dashed-line representation of a cubical unipolar magnet being levitated by a bipolar magnet in a cubical enclosure.

### DESCRIPTION OF PREFERRED EMBODIMENT

Listed numerically below with reference to the drawings are terms used to describe features of this invention. These terms and numbers assigned to them designate the same features throughout this description.

```
  1. External magnetic pole
  2. Internal magnetic pole
  3. Sidewalls
  4. Wafer magnets
  5. Hollow unipolar-magnetic object
  6. Spherically arcuate wafer magnets
  7. Electromagnet
  8. Magnetic lifter
  9. Handle and line attachment
10. Power line
11. Lift handle
12. Permanent-magnet rotor
13. Rotor axle
14. First end wall
15. Second end wall
16. Magnetic fin
17. Fin magnetic surface
18. Non-magnetic surface
19. Stator magnets
20. Unitary unipolar-magnetic object
21. Bowl magnet
22. Housed magnet
23. Housing
24. Cubic magnetic enclosure
25. Magnetic insulation
26. End insulation
27. Tool handle
```

Referring to the FIGS, one or more external magnetic poles 1 is oppositely charged magnetically from one or more internal magnetic poles 2 of a unipolar-magnetic object. The unipolar-magnetic system can include a unipolar-magnetic object on which the one or more external magnetic poles 1 are north and the one or more internal magnetic poles 2 are south. Optionally, the unipolar-magnetic system can include a unipolar-magnetic object on which the one or more external magnetic poles 1 is south and the one or more internal magnetic poles 2 is north.

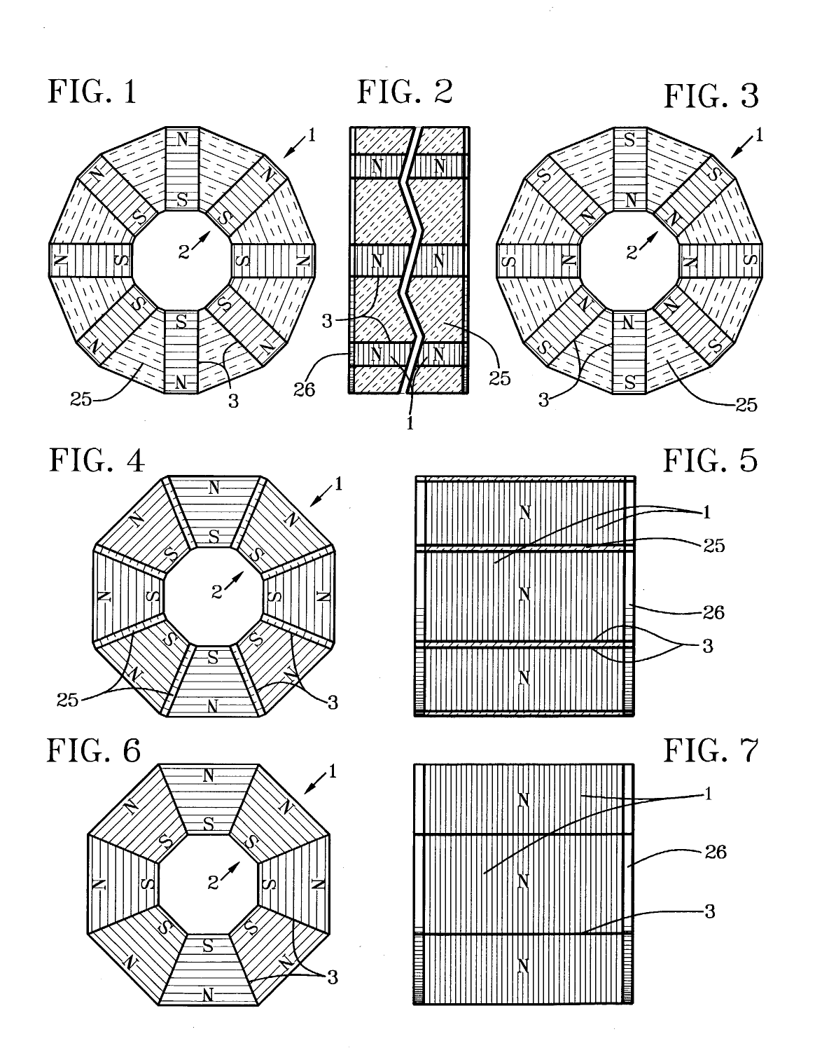

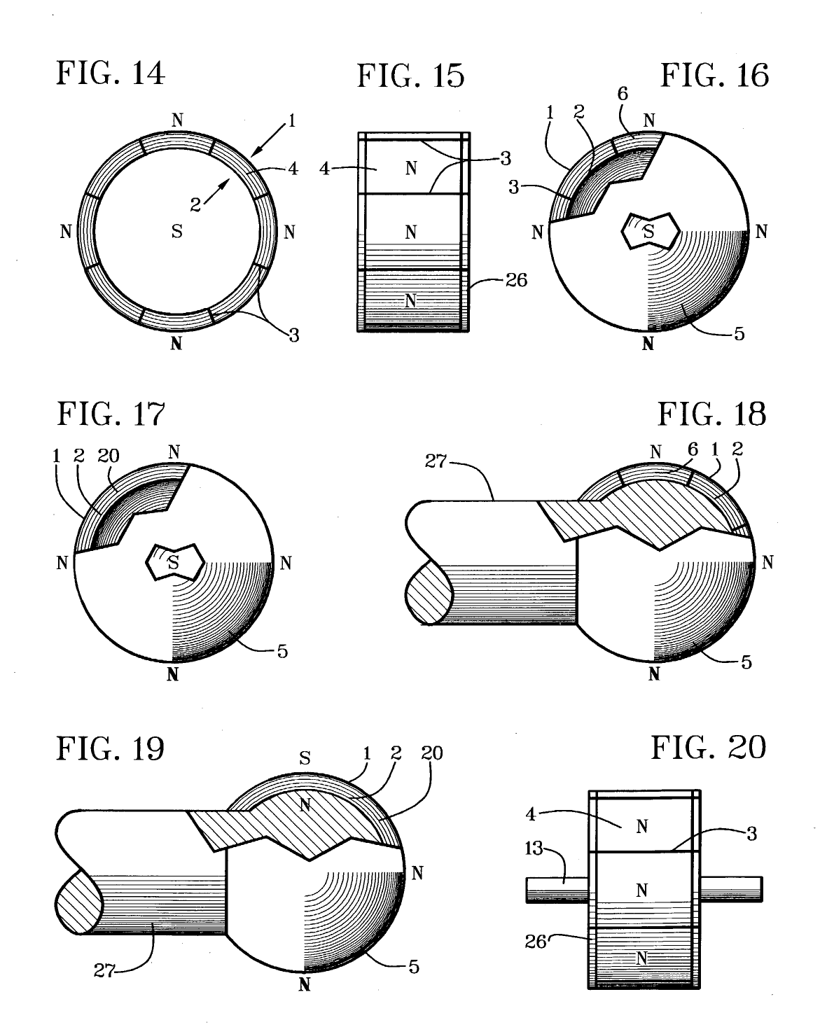

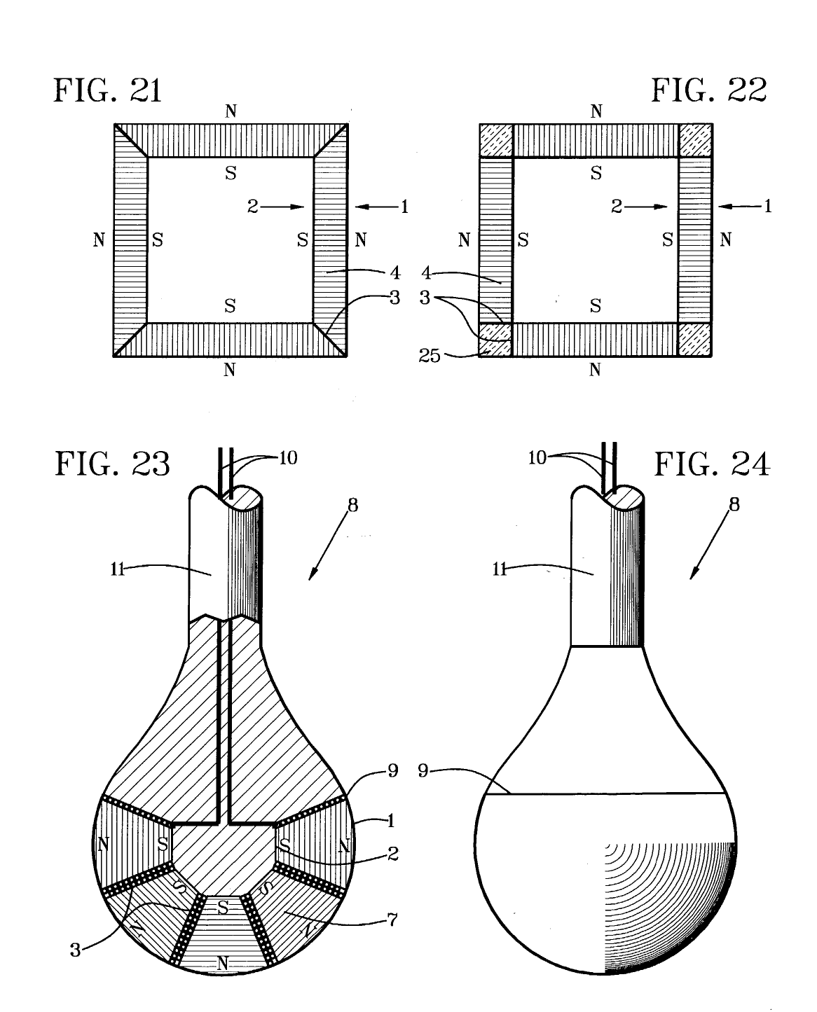

As shown in FIGS. 1-11, 14-16, 18, 20-23, 25-26 and 28-29, the unipolar-magnetic system can include a plurality of magnetically bipolar magnets which each have the commonly magnetic external pole 1 that is external from the commonly magnetic internal pole 2 which is oppositely charged magnetically from the commonly magnetic external pole 1 of each of the plurality of bipolar magnets of a unipolar-magnetic object. As shown in FIGS. 1-2, 4-8, 10, 14-16, 20-26 and 28-29, the unipolar-magnetic system can include a unipolar-magnetic object for which the external magnetic pole 1 of each of the plurality of magnetically bipolar magnets is north and the internal magnetic pole 2 of each of the plurality of magnetically bipolar magnets is south. Optionally, as shown in FIGS. 3 and 11, the unipolar-magnetic system can include a unipolar-magnetic object for which the external magnetic pole 1 of each of the plurality of magnetically bipolar magnets is south and the internal magnetic pole 2 of each of the plurality of magnetically bipolar magnets is north.

As shown in FIGS. 1-5, and 8-9, the plurality of magnetically bipolar magnets can include sidewalls 3 that are adjacent to and separated by magnetic insulation 25 from sidewalls 3 of peripherally juxtaposed sidewalls 3 of the plurality of magnetically bipolar magnets of the unipolar-magnetic object.

As shown in FIGS. 6-7, 10-11, 14-16, 20-21, 25-26 and 28-29, the plurality of magnetically bipolar magnets can include the sidewalls 3 that are adjacent to and in contact with sidewalls 3 of peripherally juxtaposed sidewalls 3 of the plurality of magnetically bipolar magnets of the unipolar-magnetic object. The plurality of magnetically bipolar magnets can include sidewalls 3 that are positioned in a nonconductive matrix with magnetically leakproof magnetic insulation 25 intermediate the sidewalls 3.

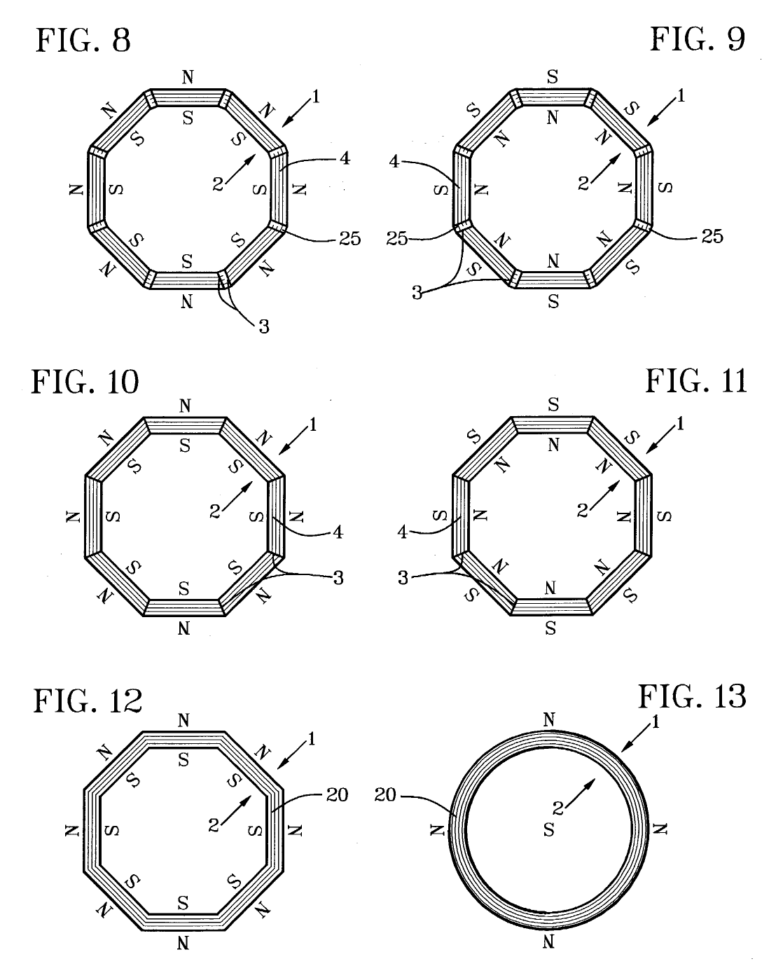

The unipolar-magnetic object can include at least part of a polyhedron and the magnetic external pole 1 of each of the magnetically bipolar magnets can be on a plane face of the polyhedron or portion thereof. As shown in FIGS. 8-11 and 21-22, the plurality of magnetically bipolar magnets can include wafer magnets 4 which have breadths between sides of the sidewalls 3 which are predeterminedly wider than lengths between the oppositely charged magnetic poles 1 and 2.

As shown in FIGS. 16-17 and 28, the unipolar-magnetic object can include a hollow unipolar-magnetic object 5, the wafer magnets 4 can include external magnetic poles 1 proximate external faces of the hollow unipolar-magnetic object 5 and the wafer magnets 4 can include internal magnetic poles 2 proximate internal faces of the hollow unipolar-magnetic object 5. The hollow unipolar-magnetic object 5 can include an internal periphery having internal lengths between inside walls proportioned to the breadths and lengths of the wafer magnets for a predetermined ratio of peripheral size to weight of the hollow unipolar-magnetic object. The plurality of magnetically bipolar magnets can include spherically arcuate wafer magnets 6 which have arcuate breadths of external magnetic poles 1 and internal magnetic poles 2 between sidewalls 3 which are predeterminedly wider than lengths between the oppositely charged magnetic poles.

The unipolar-magnetic object 5 can include a hollow sphere. The spherically arcuate wafer magnets 6 can include external magnetic poles 1 proximate an external face of the hollow sphere and the spherically arcuate wafer magnets 6 can include internal magnetic poles 2 proximate an internal face of the hollow sphere. The hollow sphere can include an internal periphery having an internal circumference with a length proportioned to the breadths and lengths of the spherically arcuate wafer magnets 6 for a predetermined ratio of peripheral size to weight of the hollow sphere.

As shown in FIGS. 18-19, a tool handle 27 can be extended from a partial enclosure of the hollow unipolar-magnetic object 5 or of the unitary unipolar-magnetic object 20 for use as a magnetic cleaner.

As shown in FIG. 23, the plurality of magnetically bipolar magnets can include electromagnets 7. The unipolar magnetic object can include a magnetic lifter 8 for lifting, drawing and pulling magnetically attractable items predeterminedly. The magnetic lifter 8 can include a handle and line attachment 9 in communication intermediate an external periphery and an internal periphery of the magnetic lifter 8. The handle and line attachment 9 can include entrance area for receiving the power line 10 and a lift handle 11 for attachment to the plurality of magnetically bipolar magnets of the magnetic lifter 8 predeterminedly.

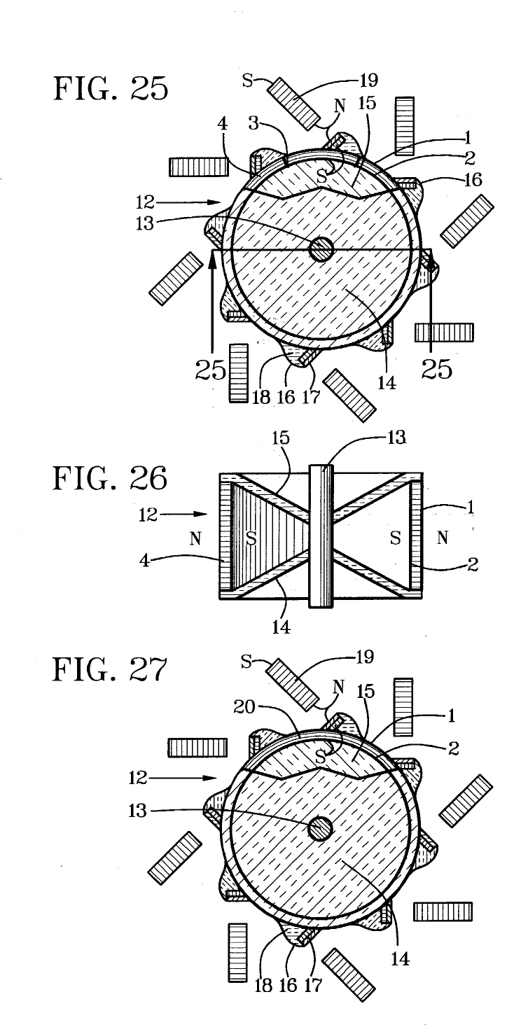

As shown in FIGS. 25-27, the unipolar-magnetic object can include a permanent-magnet rotor 12 having a rotor axle 13 that is positioned centrally to an outside periphery of the permanent-magnet rotor 12 and parallel to an axis of the permanent-magnet rotor 12. The rotor axle 13 is articulated for transmitting rotational travel of the permanent-magnet rotor 12 to predetermined machinery.

The permanent-magnet rotor 12 has an outside circumferential periphery on which a plurality of magnetically bipolar wafer magnets 4 are juxtaposed side-by-side circumferentially with a commonly magnetic external magnetic pole 1 of each of the wafer magnets 5 facing outward radially from the outside circumferential periphery and with a commonly magnetic internal magnetic pole 2 of each of the wafer magnets facing inward centrally towards the rotor axle 13. The permanent-magnet rotor 12 can include a first end wall 14 intermediate a first end of the outside circumferential periphery and a central portion of the pernanent-magnet rotor 12. The permanent-magnet rotor 12 can include a second end wall 15 intermediate a second end of the outside circumferential periphery and the central portion of the permanent-magnet rotor 12.

The outside circumferential periphery of the permanent-magnet rotor 12 is articulated for preventing magnetic force from passing between adjacent sides of the wafer magnets 4. The first end wall 14 and the second end wall 15 are articulated for preventing magnetic force from contacting first and second ends of the wafer magnets 4 and from contacting the commonly magnetic internal pole 2 of each of the wafer magnets 5. The wafer magnets 4 are articulated with predetermined thinness intermediate commonly magnetic external poles 1 and commonly magnetic internal poles 2 thereof. The rotor axle 13, the outside circumferential periphery, first end wall 14 and the second end wall 15 of the permanent-magnetic rotor 13 are articulated with predetermined light weight.

A plurality of magnetic fins 16 can be oriented predeterminedly outward from the outside periphery of the permanent-magnet rotor 12. The magnetic fins 16 can include planar surfaces which are oriented parallel to an axis of the rotor axle 13. The planar surfaces can include fin magnetic surfaces 17 which are oppositely disposed from fin non-magnetic surfaces 18 on the magnetic fins 16. The fin magnetic surfaces 17 include fin magnetic polarity that is common to magnetic polarity of the external magnetic pole 1 of each of the wafer magnets 4 on the outside circumferential periphery of the permanent-magnet rotor 12 for rotating the permanent-magnet rotor 12 with magnetic-resistence force from stator magnets 19 having stator-magnetic polarity that is common to the fin magnetic polarity radially outward from the magnetic fins 16 predeterminedly. The fin magnetic surfaces 17 in the outside periphery of the permanent-magnet rotor 12 can be optionally inwardly or outwardly protruding within the scope of this invention.

As shown in FIG. 27, a magnetically unipolar magnet can have an external magnetic pole 1 that is external radially outward from an internal magnetic pole 2 which is oppositely charged magnetically from the external magnetic pole 1 of a unitary unipolar-magnetic object 20 that is shown in FIGS. 12-13, 17, 19 and 27. The unipolar-magnetic system can include a unitary unipolar-magnetic object 20 on which the external magnetic pole 1 is north and the internal magnetic pole 2 is south as shown in FIGS. 12-13, 17, and 27. As shown in FIG. 19, the unipolar-magnetic system can include a unitary unipolar-magnetic object 20 on which the external magnetic pole 1 can be south and the internal magnetic pole 2 can be north.

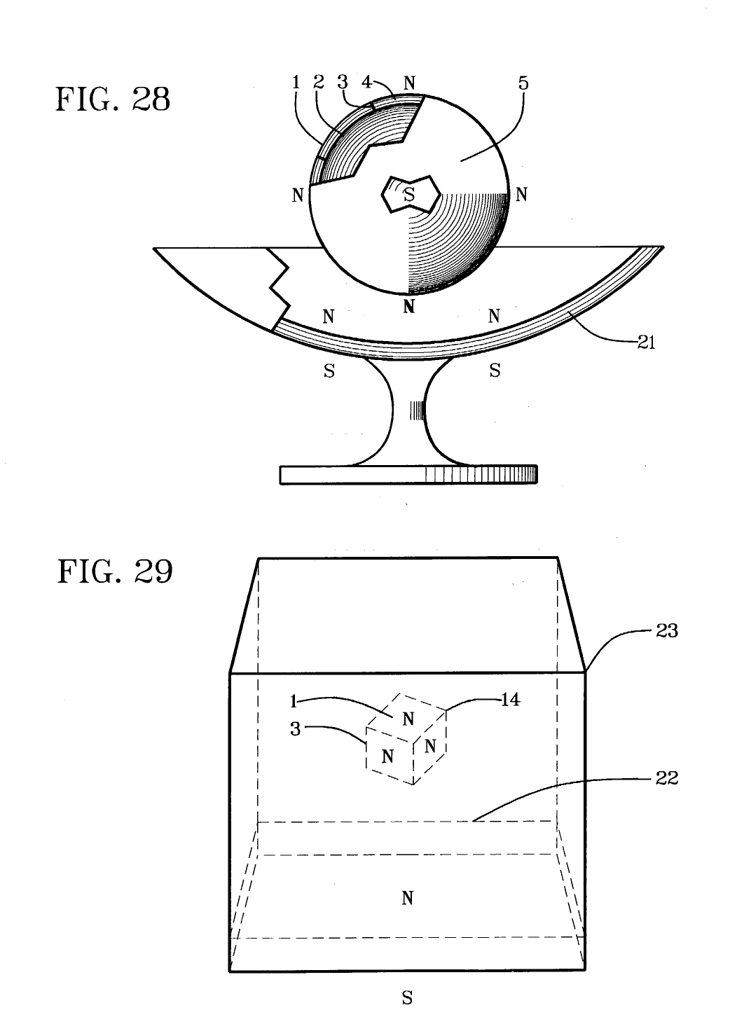

Referring further to FIGS. 25-29, one or more external magnetic poles 1 can be oppositely charged magnetically from one or more internal magnetic poles 2 of a unipolar-magnetic object and one or more resistance-force magnets can have a same pole as the unipolar-magnetic object positioned in same-pole magnetic resistance to the external magnetic pole 1 of the unipolar-magnetic object. As shown in FIGS. 25-27, the resistance-force magnet can include the one or more stator magnets 19 and the unipolar-magnetic object can include the peimanent-magnet rotor 12. As shown in FIG. 28, the resistance-force magnet can include one or more bowl magnets 21 and the unipolar-magnetic object can include a peimanent-magnet enclosure which can include the hollow unipolar magnet 5. As shown in FIG. 29, the resistance-force magnet can include a housed magnet 22 and the permanent-magnet enclosure can be articulated to be levitated by the housed magnet 22 in a portion of a housing 23 vertically above the housed magnet 22. The permanent-magnet enclosure can include a cubic magnetic enclosure 24.

A new and useful unipolar-magnetic system having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A unipolar-magnetic system comprising:
one or more external magnetic poles oppositely charged magnetically from one or more internal magnetic poles of a unipolar-magnetic object.

2. The unipolar-magnetic system of claim 1 wherein:
the unipolar-magnetic system includes a unipolar-magnetic object on which the one or more external magnetic poles are north and the one or more internal magnetic poles are south.

3. The unipolar-magnetic system of claim 1 wherein:
the unipolar-magnetic system includes a unipolar-magnetic object on which the one or more external magnetic poles are south and the one or more internal magnetic poles are north.

4. A unipolar-magnetic system comprising:
a plurality of magnetically bipolar magnets which each have a commonly magnetic external pole that is external from a commonly magnetic internal pole which is oppositely charged magnetically from the commonly magnetic external pole of each of the plurality of bipolar magnets of a unipolar-magnetic object.

5. The unipolar-magnetic system of claim 4 wherein:
the unipolar-magnetic system includes a unipolar-magnetic object for which the external magnetic pole of each of the plurality of magnetically bipolar magnets is north and the internal magnetic pole of each of the plurality of magnetically bipolar magnets is south.

6. The unipolar-magnetic system of claim 4 wherein:
the unipolar-magnetic system includes a unipolar-magnetic object for which the external magnetic pole of each of the plurality of magnetically bipolar magnets is south and the internal magnetic pole of each of the plurality of magnetically bipolar magnets is north.

7. The unipolar-magnetic system of claim 4 wherein:
the plurality of magnetically bipolar magnets include sidewalls that are adjacent to and separated by magnetic insulation from sidewalls of peripherally juxtaposed sidewalls of the plurality of magnetically bipolar magnets of the unipolar-magnetic object.

8. The unipolar-magnetic system of claim 4 wherein:
the plurality of magnetically bipolar magnets include sidewalls that are adjacent to and in contact with sidewalls of peripherally juxtaposed sidewalls of the plurality of magnetically bipolar magnets of the unipolar-magnetic object.

9. The unipolar-magnetic system of claim 4 wherein:
the plurality of magnetically bipolar magnets include wafer magnets which have breadths between sides which are predeterminedly wider than lengths between the oppositely charged magnetic poles.

10. The unipolar-magnetic system of claim 9 wherein:
the unipolar-magnetic object includes a hollow unipolar-magnetic object;
the wafer magnets include external magnetic poles proximate external faces of the hollow unipolar-magnetic object; and
the wafer magnets include internal magnetic poles proximate internal faces of the hollow unipolar-magnetic object.

11. The umpolar-magnetic system of claim 10 wherein:
the hollow unipolar-magnetic object includes an internal periphery having internal lengths between inside walls proportioned to the breadths and lengths of the wafer magnets for a predetermined ratio of peripheral size to weight of the hollow unipolar-magnetic object.

12. The unipolar-magnetic system of claim 4 wherein:
the plurality of magnetically bipolar magnets include spherically arcuate wafer magnets which have arcuate breadths of external poles and internal poles between sides which are predeterminedly wider than lengths between the oppositely charged magnetic poles.

13. The unipolar-magnetic system of claim 12 wherein:
the unipolar-magnetic object includes a hollow sphere;
the spherically arcuate wafer magnets include external magnetic poles proximate an external face of the hollow sphere; and
the spherically arcuate wafer magnets include internal magnetic poles proximate an internal face of the hollow sphere.

14. The unipolar-magnetic system of claim 13 wherein:
the hollow sphere includes an internal periphery having an internal circumference with a length proportioned to the breadths and lengths of the spherically arcuate wafer magnets for a predetermined ratio of peripheral size to weight of the hollow sphere.

15. The unipolar-magnetic system of claim 4 wherein:
the plurality of magnetically bipolar magnets include electromagnets.

16. The unipolar-magnetic system of claim 15 wherein:
the unipolar magnetic object includes a magnetic lifter for lifting, drawing and pulling magnetically attractable items predeterminedly;
the magnetic lifter is attachable to at least one power line internally from internal poles of the electromagnets;
the magnetic lifter includes a line entrance in communication intermediate an external periphery and an internal periphery of the magnetic lifter; and
the line entrance includes entrance area for receiving the power line and a lift handle for attachment to the plurality of magnetically bipolar magnets of the magnetic lifter predeterminedly.

17. The unipolar-magnetic system of claim 4 wherein:
the unipolar-magnetic object includes a permanent-magnet rotor having a rotor axle that is positioned centrally to an outside periphery of the permanent-magnet rotor and parallel to an axis of the permanent-magnet rotor;
the rotor axle is articulated for transmitting rotational travel of the permanent-magnet rotor to predetermined machinery;
the permanent-magnet rotor has an outside circumferential periphery;
a plurality of magnetically bipolar wafer magnets are juxtaposed side-by-side circumferentially on the outside circumferential periphery with a commonly magnetic external pole of each of the wafer magnets facing outward radially from the outside circumferential periphery and with a commonly magnetic internal pole of each of the wafer magnets facing inward centrally towards the rotor axle;
the permanent-magnet rotor includes a first end wall intermediate a first end of the outside circumferential periphery and a central portion of the permanent-magnet rotor;
the permanent-magnet rotor includes a second end wall intermediate a second end of the outside circumferential periphery and the central portion of the permanent-magnet rotor;
the outside circumferential periphery of the permanent-magnet rotor is articulated for preventing magnetic force from passing between adjacent sides of the wafer magnets;
the first end wall and the second end wall are articulated for preventing magnetic force from contacting first and second ends of the wafer magnets and from contacting the commonly magnetic internal pole of each of the wafer magnets;
the wafer magnets are articulated with predetermined thinness intermediate commonly magnetic external poles and commonly magnetic internal poles thereof; and
the rotor axle, the outside circumferential periphery, first end wall and the second end wall of the permanent-magnetic rotor are articulated for predetermined light weight.

18. The unipolar-magnetic system of claim 17 and further comprising:
a plurality of magnetic fins which are oriented predeterminedly from the outside periphery of the permanent-magnet rotor; and
the magnetic fins include planar surfaces which are oriented parallel to an axis of the rotor axle.

19. The unipolar-magnetic system of claim 18 wherein:
the fin magnetic surfaces include fin magnetic polarity that is common to magnetic polarity of the magnetic external pole of each of the wafer magnets on the outside circumferential periphery of the permanent-magnet rotor for rotating the permanent-magnet rotor with magnetic-resistence force from stator magnets having stator-magnetic polarity that is common to the fin magnetic polarity radially outward from the magnetic fins predeterminedly.

20. A unipolar-magnetic system comprising:
a magnetically unipolar magnet having an external magnetic pole that is external radially outward from an internal magnetic pole which is oppositely charged magnetically from the external magnetic pole of a unitary unipolar-magnetic object.

21. The unipolar-magnetic system of claim 20 wherein:
the unipolar-magnetic system includes a unitary unipolar-magnetic object on which the external magnetic pole is north and the internal magnetic pole is south.

22. The unipolar-magnetic system of claim 20 wherein:
the unipolar-magnetic system includes a unitary unipolar-magnetic object on which the external magnetic pole is south and the internal magnetic pole is north.

23. The unipolar-magnetic system of claim 20 wherein:
the unitary unipolar-magnetic object includes a hollow unitary magnet with a first magnetic polarity facing peripherally outward and a second magnetic polarity facing peripherally inward.

24. A unipolar-magnetic system comprising:
one or more external magnetic poles oppositely charged magnetically from one or more internal magnetic poles of a unipolar-magnetic object; and
one or more resistance-force magnets having a same pole as the unipolar-magnetic object positioned with same-pole magnetic resistance to the external magnetic pole of the unipolar-magnetic object.

25. The unipolar-magnetic system of claim 24 wherein:
the resistance-force magnet includes one or more stator magnets; and
the unipolar-magnetic object includes a peimanent-magnet rotor.

26. The unipolar-magnetic system of claim 24 wherein:
the resistance-force magnet includes one or more levitation-base magnets; and
the unipolar-magnetic object includes a permanent-magnet enclosure.

27. The unipolar-magnetic system of claim 26 wherein:
the levitation-base magnet includes a bowl magnet; and
the permanent-magnet enclosure is articulated to be levitated by the bowl magnet.

28. The unipolar-magnetic system of claim 26 wherein:
the levitation-base magnet includes a housed magnet; and
the permanent-magnet enclosure is articulated to be levitated by the housed magnet in a portion of a housing vertically above the housed magnet.
